(19) United States
(12) Patent Application Publication
(10) Pub. No.: US 2022/0320587 A1
(43) Pub. Date: Oct. 6, 2022

(54) NON-CARBONATE ELECTROLYTES STABILIZE SILICON ANODES

(71) Applicant: UT-Battelle, LLC, Oak Ridge, TN (US)

(72) Inventors: Jagjit Nanda, Knoxville, TN (US); Guang Yang, Knoxville, TN (US); Gabriel M. Veith, Knoxville, TN (US)

(21) Appl. No.: 17/713,449

(22) Filed: Apr. 5, 2022

Related U.S. Application Data
(60) Provisional application No. 63/170,901, filed on Apr. 5, 2021.

(51) Int. Cl. H01M 10/0569; H01M 10/0525; H01M 10/0568; H01M 10/0567

(52) U.S. Cl. CPC H01M 10/0569; H01M 10/0525; H01M 10/0568; H01M 10/0567; H01M 4/58

(57) ABSTRACT

A battery includes a cathode, an anode comprising Si, an electrolyte comprising glyme, and a lithium salt having at least one fluorine or boron atom in the anion. The glyme can have the formula CH₃(OCH₂CH₂)ₙOCH₃, where 1≤n≤4. The glyme can have the formula CₙH₂ₙOₘ, where 8≥n≥4 and 4≥m≥1. The electrolyte can further include an additive, wherein the additive has low solubility for the lithium salts such that the additive does not change the coordination of the ions in the glyme, has a viscosity<1 cP at 25° C., and is miscible with the glyme. An electrolyte for a battery and a method of making a battery are also discussed.

### CROSS-REFERENCE TO RELATED APPLICATIONS

This application claims priority to U.S. 63/170,901 filed on Apr. 5, 2021, entitled “NON-CARBONATE ELECTROLYTES TO PROLONG CALENDAR LIFE AND CYCLING LIFE OF SI CELLS”, the entire disclosure of which incorporated herein by reference.

### STATEMENT REGARDING FEDERALLY SPONSORED RESEARCH AND DEVELOPMENT

This invention was made with government support under Contract No. DE-AC05-000R22725 awarded by the United States Department of Energy. The government has certain rights in this invention.

### FIELD OF THE INVENTION

The present invention relates generally to battery electrolytes, and more specifically to electrolytes for use with Si, Sb, Sn, and Ge anodes.

### BACKGROUND OF THE INVENTION

Due to its ultrahigh theoretical lithium storage capacity (3579 mAh g⁻¹ for Li₁₅Si₄), silicon has been considered a promising alternative anode to graphite in lithium-ion batteries (LIBs). Electrolytes are one of the most essential components and are often determinative in the cycling stability of LIBs. The reduction decomposition of the electrolyte components generates a passivation layer, the so-called solid/electrolyte interphase (SEI), to protect the electrolyte from further decomposition. Common carbonate-based electrolytes optimized to stabilize the graphite anode/electrolyte interphase for state-of-the-art LIBs insufficiently passivate the silicon anode. Structural disruption during cycling results in ˜300% volumetric change of the Si anode. The subsequent Si fracture inevitably deteriorates the superficial SEI layer. Further, the decomposition products of the carbonate-based electrolytes such as lithium ethylene dicarbonate (LiEDC) are reactive on the Si surface. Taken together, the application of carbonate-based electrolytes generates an inherently unstable SEI, leading to continuous electrolyte decomposition and Li consumption on Si surface, causing rapid degradation of the LIB overtime.

Extensive attempts have been made to promote Si cyclability using carbonate-based additives. An addition of less than 10 wt % fluoroethylene carbonate (FEC) has been shown to drastically improve the charge/discharge stability. The beneficial role of FEC degradation in stabilizing Si anodes is thought to occur via a) facilitating earlier formation of the passivation layer at a higher reduction potential to mitigate the decomposition of other electrolyte components, and b) mitigating the poly(ethylene oxide) (PEO)-like oligomeric electrolyte breakdown products by forming a cross-linked polyether network. The insolubility of the cross-linked polymeric species appears crucial to accommodating severe Si volumetric change upon cycling, thereby stabilizing the Si surface and enabling capacity retention. Despite early successes, carbonate additives have seen intrinsic limitations to ameliorate instability of the SEI on Si.

### SUMMARY OF THE INVENTION

A battery includes a cathode, an anode comprising Si, an electrolyte comprising glyme, and a lithium salt having at least one fluorine or boron atom in the anion. The glyme can have the formula CH₃(OCH₂CH₂)ₙOCH₃, where 1≤n≤4. The glyme can be is at least one selected from the group consisting of Dimethoxyethane (glyme), Bis(2-methoxyethyl) ether (diglyme), Triethylene glycol dimethyl ether (triglyme), and Tetraethylene glycol dimethyl ether (tetraglyme). The glyme can have the formula CₙH₂ₙOₘ, where 8≥n≥4 and 4≥m≥1. The glyme can be at least one selected from the group consisting of Tetrahydrofuran, Tetrahydropyran, and 1,4-Dioxane. The electrolyte dynamic viscosity can be <5 mm²/s. The mS/cm room temperature ionic conductivity is greater than 1 mS/cm and less than 100 mS/cm.

The lithium salt can be a lithium imide salt. The lithium imide salt can be at least one selected from the group consisting of lithium triflouromethanesulfonate (LiOTF), lithium bis(fluorosulfonyl)imide (LiFSI), lithium bis(trifluoromethanesulfonyl)imide (LiTFSI), lithium triflorite (LiTf), lithium bis(pentafluoroethanesulfonyl)imide (LiBETI). The lithium salt can be a lithium borate salt. The lithium borate salt can be at least one selected from the group consisting of lithium bis(oxalato)borate (LiBOB), lithium tetrafluoroborate (LiBF₄), and lithium difluoro(oxalato)borate (LiODFB).

The glyme has ether oxygen, and the molar ratio of lithium salt to ether oxygen can be less than 5:1. The lithium salt can be a mixture of at least one lithium imide salt and at least one lithium borate salt. The molar ratio of lithium imide salt to lithium borate salt is ≥1:1.

The electrolyte can further include an additive, wherein the additive has low solubility for the lithium salts such that the additive does not change the coordination of the ions in the glyme, has a viscosity<1 cP at 25° C., and is miscible with the glyme. The molar ratio of glyme to additive can be ≥1:1. The additive can have an electrochemical stability window>4.2V.

The additive can be at least one selected from the group consisting of fluoroethers and fluoroesters. Suitable fluoroether additives include at least one selected from the group consisting of 2,2,3,3-tetrafluoropropyl ether (TTE), bis(2,2,2-trifluoroethyl) ether (BTFE), and 1,1,2,2-tetrafluoroethyl-2,2,3,3-tetrafluoropropyl ether. Suitable fluoroester additives include fluoroethylene carbonate.

The anode can be comprised of at least one selected from the group consisting of Si, Ge, Sb and Sn both in their crystalline, semi-crystalline and amorphous forms. The anode can further comprise carbon black and binders.

The cathode can be at least one selected from the group consisting of lithium iron phosphate battery low voltage cathodes up to 3.8 V vs. Li, and nickel manganese cobalt (NMC) high voltage cathodes up to 4.2 V vs. Li.

An electrolyte for a battery with an anode can include at least one selected from the group consisting of Si, Ge, Sb and Sn, and includes glyme and a lithium salt having at least one fluorine or boron atom in the anion, the glyme having a formula comprising at least one selected from the group consisting of CH₃(OCH₂CH₂)ₙOCH₃, where 1≤n≤4, and CₙH₂ₙOₘ, where 8≥n≥4 and 4≥m≥1. The electrolyte can further include an additive, wherein the additive has low solubility for the lithium salts such that the additive does not change the coordination of the ions in the glyme, has a viscosity<1 cP at 25° C., and is miscible with the glyme.

A method of making a battery can include the steps of providing a cathode, providing an anode including at least one selected from the group consisting of Si, Sb, Sn and Ge, and positioning between the anode and the cathode an electrolyte comprising glyme, and a lithium salt comprising at least one fluorine or boron atom in the anion. The glyme can include at least one selected from the group consisting of CH₃(OCH₂CH₂)ₙOCH₃, where 1≤n≤4, and CₙH₂ₙOₘ, where 8≥n≥4 and 4≥m≥1. The electrolyte further can further include an additive, wherein the additive has low solubility for the lithium salts such that the additive does not change the coordination of the ions in the glyme, has a viscosity<1 cP at 25° C., and is miscible with the glyme.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a plot of normalized specific capacity vs. cycle number for reference electrolytes and electrolytes according to the invention.

FIG. 2 is a plot of coulombic efficiency (CE) vs. cycle number.

FIG. 3 is a plot of voltage (V) vs. specific capacity (mAh/g) for a GenF electrolyte cycled at 2C.

FIG. 4 is a plot of voltage (V) vs. specific capacity (mAh/g) obtained with a GenF electrolyte cycled at C/3.

FIG. 5 is a plot of voltage (V) vs. specific capacity (mAh/g) obtained with a LiFSI-3DME-3TTE electrolyte cycled at 2C.

FIG. 6 is a plot of voltage (V) vs. specific capacity (mAh/g) for a LiFSI-3DME-3TTE electrolyte cycled at C/3.

FIG. 7 is a plot of specific capacity (mAh/g) vs. cycle number for GenF and LiFSI-3DME-3TTE electrolytes cycled at 2C.

FIG. 8 is a plot of specific capacity (mAh/g) vs. cycle number for GenF and LiFSI-3DME-3TTE electrolytes cycled at C/3.

FIG. 9 are SEMs of LiFSI-3DME-3TTE and GenF electrolytes that have been cycled at 2C and C/3.

FIG. 10 is a plot of −Im Z″ (Ohm cm⁻²) vs. Re Z′ (Ohm cm⁻²) for different electrolytes.

FIG. 11 is a plot of RSEI (Ohm cm²) vs. cycle number for different electrolytes.

FIG. 12 are SEM micrographs and EDX mapping.

FIG. 13 is a reaction scheme for the formation of an SEI layer from a glyme electrolyte.

FIG. 14 is a plot of voltage (V) vs. specific capacity (mAh/g) showing charge-discharge curves for Si composite electrode/NMC532 full cells cycled using GenF.

FIG. 15 is a plot of voltage vs. specific capacity (mAh/g) showing charge-discharge curves for Si composite electrode/NMC532 full cells cycled using LiFSI-3DME-3TTE electrolyte.

FIG. 16 is a plot of specific capacity (mAh/g) vs. cycle number showing the cycling performance of the Si composite electrode/NMC532 full cells evaluated based on the discharge capacity as a function of the cycle number.

FIG. 17 is a plot of voltage (V) vs. time (hours) showing the calendar life test protocol.

FIG. 18 is a plot of specific capacity measured for different electrolyte types.

FIG. 19 is a plot of current (Amps/Ah) vs. holding time (hours).

FIG. 20 are SEMs of the Si anode after the calendar life test, and EDX mapping of the same scanned area for each sample.

FIG. 21 are photographs that show Si flakes from the current collector after the calendar life test with different electrolytes.

### DETAILED DESCRIPTION OF THE INVENTION

Commercial carbonate electrolytes form an unstable solid-electrolyte interphase (SEI) on high-capacity Si anodes. Glyme-based electrolytes promote formation of a more stable SEI on the Si surface than the optimal carbonate electrolytes containing fluoroethylene carbonate. The glyme-based electrolytes demonstrate reduced Si/electrolyte interfacial resistance, charge/discharge polarization and exhibit enhanced cycling performance. A comparative study of the chemistry of SEIs formed with glyme-based electrolytes and carbonate electrolytes indicates that the former contains less carbonate compounds and an increased abundance of polyether. The polyether promotes SEI elasticity such that conformal SEI coverage is maintained, thereby mitigating excessive SEI formation and Si fracture that contribute to capacity fade in the Si-based battery anode. Glyme-based electrolytes prove viable in stabilizing the Si/SEI interface to enable future high energy density lithium-ion batteries.

A battery can include a cathode, an anode comprising Si, an electrolyte comprising glyme, and a lithium salt having at least one fluorine or boron atom in the anion. The glyme can have the formula CH₃(OCH₂CH₂)ₙOCH₃, where 1≤n≤4. Different glymes are possible. Examples of suitable linear glymes include Dimethoxyethane (glyme), Bis(2-methoxyethyl) ether (diglyme), Triethylene glycol dimethyl ether (triglyme), and Tetraethylene glycol dimethyl ether (tetraglyme). The glyme can also be cyclic and can have the formula CₙH₂ₙOₘ, where 8≥n≥4 and 4≥m≥1. Suitable cyclic glymes include Tetrahydrofuran, Tetrahydropyran, and 1,4-Dioxane. Other glymes are possible.

The electrolyte dynamic viscosity can be <5 mm²/s. This will help to ensure that lithium ion transport is not hindered. The mS/cm room temperature ionic conductivity can be greater than 1 mS/cm and less than 100 mS/cm. The mS/cm room temperature ionic conductivity can be 1, 2, 3, 4, 5, 6, 7, 8, 9, 10, 15, 20, 25, 30, 35, 40, 45, 50, 55, 60, 65, 70, 75, 80, 85, 90, 95, or 100 mS/cm, and can be within a range of any high value and low value selected from these values.

The lithium salt must be compatible with the glyme. The lithium salt can be a lithium imide salt. Suitable lithium imide salts include lithium triflouromethanesulfonate (LiOTF), lithium bis(fluorosulfonyl)imide (LiFSI), lithium bis(trifluoromethanesulfonyl)imide (LiTFSI), lithium triflorite (LiTf), lithium bis(pentafluoroethanesulfonyl)imide (LiBETI). The lithium salt can be a lithium borate salt. Suitable lithium borate salts include lithium bis(oxalato)borate (LiBOB), lithium tetrafluoroborate (LiBF₄), and lithium difluoro(oxalato)borate (LiODFB).

The glyme has ether oxygen, and the molar ratio of lithium salt to ether oxygen can be less than 5:1. The molar ratio of lithium salt to ether oxygen can be 1:1, 2:1, 3:1, 4:1 and 5:1, or can be within a range of any high value and low value selected from these values. The lithium salt can be a mixture of at least one lithium imide salt and at least one lithium borate salt. The molar ratio of lithium imide salt to lithium borate salt is ≥1:1.

The electrolyte can further include an additive. The additive decreases the viscosity of the electrolyte and promotes Li cation transport. The additive has low solubility for the lithium salts such that the additive does not change the coordination of the ions in the glyme, has a viscosity<1 cP at 25° C., and is miscible with the glyme. The molar ratio of glyme to additive can be ≥1:1. The additive can have an electrochemical stability window>4.2V.

The additive can be selected from fluoroethers and fluoroesters. Suitable fluoroether additives include 2,2,3,3-tetrafluoropropyl ether (TTE), bis(2,2,2-trifluoroethyl) ether (BTFE), and 1,1,2,2-tetrafluoroethyl-2,2,3,3-tetrafluoropropyl ether. Suitable fluoroester additives include fluoroethylene carbonate.

The invention has particular utility with Si-containing anodes. The invention also has utility with anodes containing Si, Ge, Sb and Sn. Anodes with mixtures of these are possible. The anode can further comprise other compounds such as carbon black and binders.

The cathode can be at least one selected from the group consisting of lithium iron phosphate battery low voltage cathodes up to 3.8 V vs. Li, and nickel manganese cobalt (NMC) high voltage cathodes up to 4.2 V vs. Li. Examples of suitable cathodes include, without limitation, Lithium Nickel Manganese Spinel (LiNi_{0.5}Mn_{1.5}O₄) NCA—Lithium Nickel Cobalt Aluminium Oxide (LiNiCoAlO₂) LMO—Lithium Manganese Oxide (LiMn₂O₄) LCO—Lithium Cobalt Oxide (LiCoO₂).

A battery according to the invention can be made with standard production methods. A method of making a battery can include the steps of providing a cathode, providing an anode including at least one selected from the group consisting of Si, Sb, Sn and Ge, and positioning between the anode and the cathode an electrolyte comprising glyme, and a lithium salt comprising at least one fluorine or boron atom in the anion. The glyme can include one or both of CH₃(OCH₂CH₂)ₙOCH₃, where 1≤n≤4, and CₙH₂ₙOₘ, where 8≥n≥4 and 4≥m≥1. The electrolyte further can further include an additive, wherein the additive has low solubility for the lithium salts such that the additive does not change the coordination of the ions in the glyme, has a viscosity<1 cP at 25° C., and is miscible with the glyme.

Glyme-based electrolytes according to the invention promote cycling life of both Si (thin-film Si anode)-Li half-cells and Si (practical Si composite anode)-NMC cathode full cells. Glyme-based electrolytes mitigate the non-desired side reactions due to electrolyte decomposition on Si anode to extend the calendar life of Si cells. Glyme-based electrolytes mitigate the overall cell resistance. Glyme-based electrolytes form a robust SEI layer on the Si anode, and the SEI layer is conformal on Si anodes, more elastic, and the SEI layers mitigate the Si anode fracturing during cell cycling.

### Experimental

Carbonate electrolytes (GenII and GenF) were used as a benchmark. The GenII is a commercial electrolyte for Li-ion batteries. The GenF is GenII+10 wt % fluoroethylene carbonate (FEC).

Materials

The GenII electrolyte is composed of lithium hexafluorophosphate (LiPF₆, 1.2 M) in the 3:7 wt % ethylene carbonate (EC)/ethyl methyl carbonate (EMC) electrolyte (Tomiyama Chemicals, Japan). GenF electrolyte was GenII mixed with 10 wt % fluoroethylene carbonate (FEC, BASF, purity 99.94%). Bis(fluorosulfonyl)imide (LiFSI) (Solvionic, 99.9%) was dried in 100° C. in vacuum overnight before use. 1,2-dimethoxyethane (DME) (Sigma, 99.5% inhibitor free) and 1,1,2,2-tetrafluoroethyl-2,2,3,3-tetrafluoropropyl ether (TTE, 99%, Synquest Laboratories) were used as received. All electrolytes were stored with 4 \acute{Å} molecular sieve in the Ar-filled glove box.

The pristine amorphous Si (a-Si) anode was prepared by RF magnetron sputtering Si onto a copper foil, which was used as the current collector. The film thickness was 50 nm as measured by a quartz-crystal microbalance (QCM), and determined by SEM cross-section micrograph.

The graphite-free particle-based Si electrodes were prepared by laminating the Cu foil as the current collector with a slurry containing 60 wt % silicon nanoparticles, 20 wt % hard carbon additive (C45), and 20 wt % lithium polyacrylate (LiPAA) silicon compatible binder, mixed in DI water. The Si electrode has a final loading of 0.7 mg/cm² and a thickness of 9 μm (excluding the Cu foil). Such a particle-based Si sample is denoted as Si622.

The positive NMC532 electrodes were produced at the U.S. Department of Energy's (DOE) CAMP (Cell Analysis, Modeling and Prototyping) Facility, Argonne National Laboratory and consisted of 90 wt % LiNi_{0.5}Mn_{0.3}Co_{0.2}O₂(NMC532) (Toda, USA), 5 wt % C45 (Timcal/Imerys Graphite & Carbon, Switzerland), 5 wt % 5130 PVDF (Solvay, Belgium) with a loading of 11.24 mg·cm⁻². The NMC622 cathode contained 90 wt % Targray NMC622, 5 wt % Timcal C45 carbon black, and 5 wt % Solvay 5130 PVDF binder, with a loading of 9.78 mg-cm⁻². All Si anodes were dried in vacuum at 150° C. and all other electrodes were dried at 120° C. in vacuum overnight prior to use at Ar-filled glove box (O₂<0.1 ppm and H₂O<0.1 ppm).

Coin Cell Fabrication

For the Li—Si half-cell test, the as-sputtered a-Si anode was further dried in vacuum overnight before being transferred into an Ar-filled glove box (O₂<0.1 ppm and H₂O<0.1 ppm) and punched into disks (½″ or 7/16″ in diameter). The coin cells (stainless steel CR-2032, Hohsen Corp., Osaka, Japan) were assembled by using the a-Si as the working electrode, a Li disk (½″) as the counter electrode, and a polypropylene membrane (Celgard 2400) and a glass fiber nonwoven (Whatman) as the separators. For Si-NMC full-cell test, the Si622 particle-based Si electrode and the NMC532 cathode were punched into ⅝″ and 9/16″ discs, respectively. A single-layer Celgard separator was used for each coin cell.

Electrochemical Measurements

All electrochemical measurements were taken at 25 C on a Bio-Logic potentiostat (VMP-3). The galvanostatic cycling experiment was cycled between 1.5 V and 50 mV (vs. Li⁺/Li) at 1 C equivalent rate (41.7 μA/cm²). The cyclic voltammetry was measured between 1.5 V and 50 mV (vs. Li⁺/Li) at a scanning rate of 0.1 mV/s. The electrochemical impedance spectroscopy (EIS) was measured from 10⁶ Hz to 10 mHz with a spacing of 6 frequencies at open-circuit voltage increments per decade. The electrochemistry results were analyzed by EC-Lab software (version 11.27).

Calendar Life Testing

The full cell calendar life test started from a 4-hour open circuit voltage rest. Subsequently, there are three formation cycles at a C/10 rate in the voltage window of 3.0 to 4.1 V for NMC532 and 2.7 to 3.35 V for LFP followed by a one-month or three-month hold at 4.1 V or 3.35 V. Finally, there are two diagnostic cycles at C/10 rate. The cyclic performance of Si/NMC532 full cells is tested at a C/10 rate for 100 cycles.

Sample Preparation for Characterizations

After cycling, all coin cells were disassembled in an Ar-filled glovebox. (O₂<0.1 ppm and H₂O<0.1 ppm). The a-Si was at nominal. The a-Si anodes were gently rinsed in triplicate using dimethyl carbonate (DMC) (Sigma Aldrich, anhydrous, ≥99%). The excess liquid was carefully removed by placing a piece of single-ply KimWipes on the edge of the a-Si, followed by drying in the glovebox for a minimum of 2 h. The disassembled electrodes were further dried in a vacuum for 8 h before all measurements. No residual electrolyte or DMC eluent was observed from XPS.

Scanning Electron Microscope (SEM)

SEM micrographs of the a-Si were collected by a cold-cathode field emission (FE) SEM system (Hitachi S4800) at 20 kV accelerating voltage, and a 20 μA beam current. An energy dispersive X-ray spectrometer (EDX) was used to obtain the elemental composition distribution of the a-Si anode surface (20 kV, 20 μA). The EDX mappings were analyzed by an EDAX Genesis software package.

The electrolytes and electrodes used are set forth in Table 1 and Table 2 below:

TABLE 1
List of electrolytes

| Abbreviation | Component |
|---|---|
| Carbonate | |
| benchmark | |
| GenII | LiPF₆, 1.2M in the 3:7 wt % EC/EMC |
| GenF | GenII + 10 wt % FEC |
| Glyme | |
| LFSI-DME | LiFSI, 1.2M in DME |
| LFSI-DME-10 | 1.2M LiFSI in DME with 10 wt % TTE |
| wt % TTE | |
| LFSI-3DME- | LiFSI in DME and TTE with molar ratio 1:3:3 |
| 3TTE | |
| Dual salt | LiTFSI-LiDFOB in DME with 2M concentration of |
| | each salt |
| Dual salt + N2FC | Dual salt + 3 wt % N2FC phosphate additive |

TABLE 2
List of electrodes

| Abbreviation | Component |
|---|---|
| Si Anode | |
| a-Si | RF sputtered 50 nm amorphous Si thin film anode on Cu |
| | current collector |
| Si622 | 60 wt % 150 nm silicon nanoparticles, 20 wt % hard carbon |
| | additive (C45), and 20 wt % lithium polyacrylate (LiPAA) |
| | silicon compatible binder |
| Cathode | |
| Li | Li metal used for Si—Li half-cell test |
| NMC532 | 90 wt % LiNi_{0.5}Mn_{0.3}Co_{0.2}O₂ (NMC532) |
| | (Toda, USA), 5 wt % C45 (Timcal/Imerys |
| | Graphite & Carbon, Switzerland), 5 wt % 5130 PVDF |
| | (Solvay, Belgium) with a loading of 11.24 mg × |
| | cm⁻². |
| NMC622 | 90 wt % Targray NMC622, 5 wt % Timcal C45 carbon |
| | black, and 5 wt % Solvay 5130 PVDF binder, with a |
| | loading of 9.78 mg · cm⁻² |

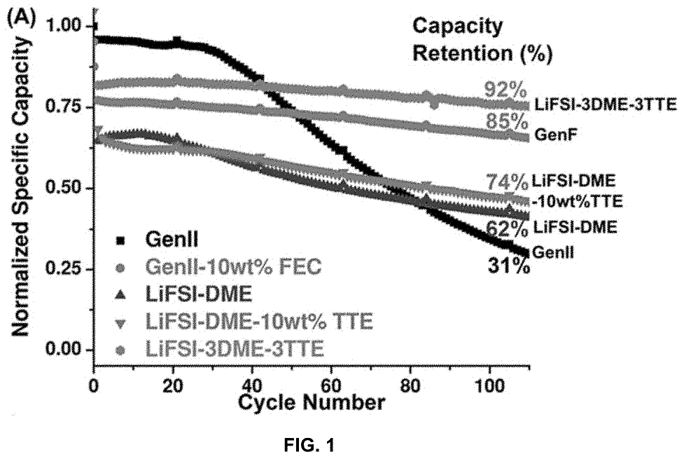

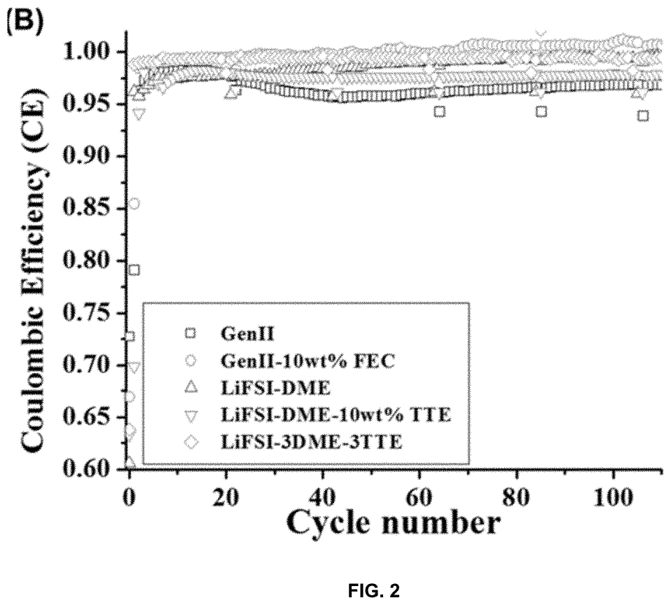

The primary advantage of LiFSI-3DME-3TTE over other electrolytes is its promoted capacity and capacity retention. FIG. 1 shows the discharge capacity and FIG. 2 shows the Coulombic efficiency as a function of cycle number. Adding 10 wt % TTE increases the capacity retention from 62% to 74% compared to LiFSI-DME, showing the importance of TTE as an additive in glyme electrolytes. All glyme electrolytes measure higher capacity retention than GenII. Notably, the average capacity of LiFSI-3DME-3TTE is 12.3% higher than GenF, with capacity retention over 7% higher than GenF. The discharge capacity was 3266 mAh/g for LiFSI-3DME-3TTE at 110^{th} cycle, 15% larger than GenF. It should be noted that higher than theoretical capacity of the Si anode during the initial cycle has been observed for all electrolytes in FIG. 1, agreeing with similar studies on Si thin film anodes. The initial capacity reduction of GenII is 96.3%. Both GenF and the LiFSI-3DME-3TTE exhibit higher initial capacity reduction values of 88.7% and 86.2%, respectively.

In addition to improved capacity and capacity retention compared to GenF, LiFSI-3DME-3TTE shows stable Columbic efficiency (CE) at an earlier point in cycling (>99%, 4^{th} cycle (FIG. 2). In contrast, GenF did not reach 99% CE until the 6^{th} cycle. Glyme electrolytes without TTE did not achieve 99% CE until 60 cycles, supporting the importance of TTE additive in the suppression of side reactions which occur earlier than those associated with FEC additive in glyme electrolytes. Both LiFSI-DME-10 wt % and GenII show CE<98.5%, with the maximum CE values in the 16^{th} cycle, indicating the importance of sacrificial additives such as TTE and FEC in the stabilization of Si anodes. LiFSI-3DME-3TTE enables an average CE of 99.4% in the final 30 cycles, comparable to state-of-the-art carbonate electrolytes and artificial SEIs engineered for the a-Si thin film anode.

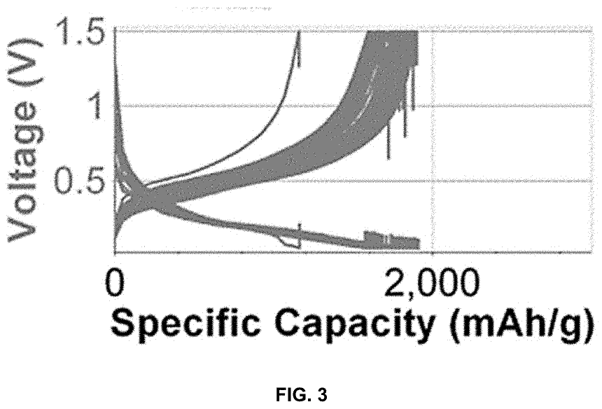

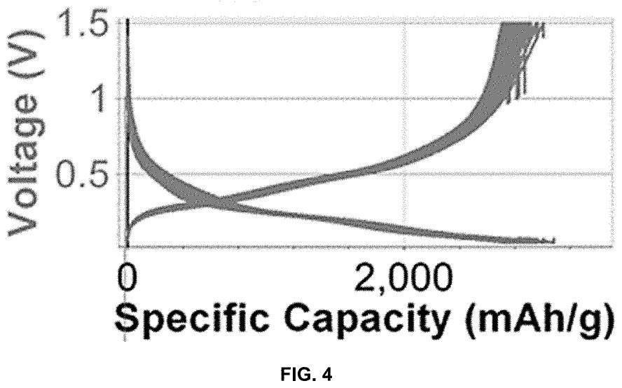

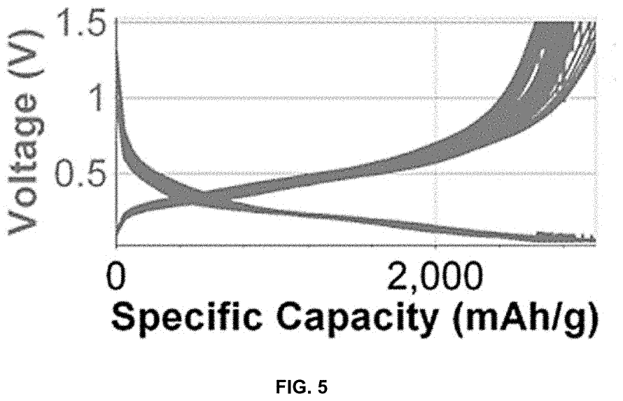

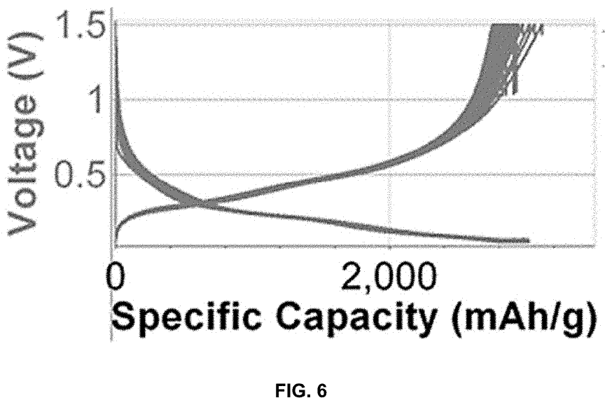

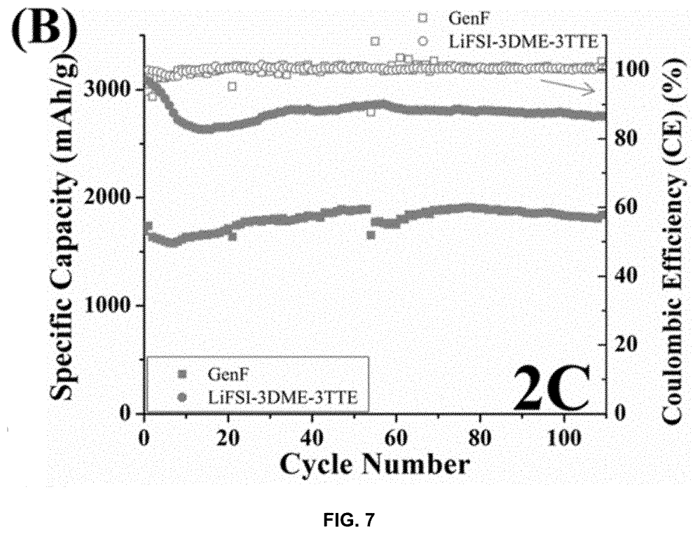

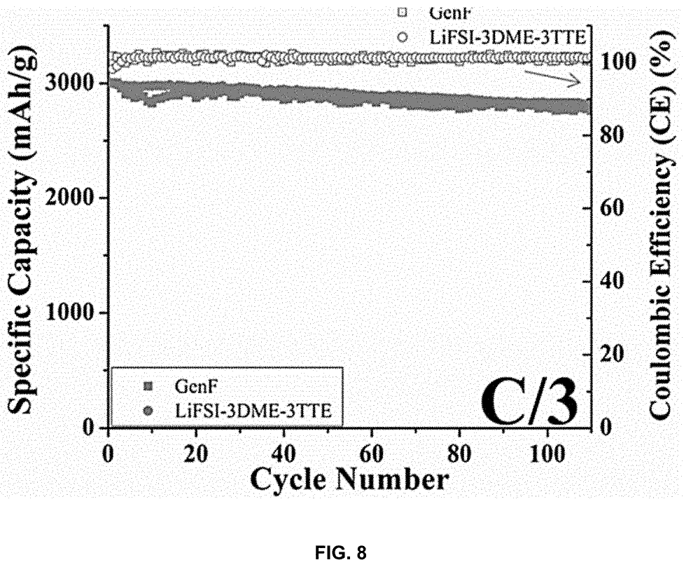

FIGS. 3, 4, 5, and 6 show galvanostatic charge/discharge curves for a-Si anode cycled in GenF baseline and LiFSI-3DME-3TTE at different C rates for 110 cycles. To investigate the C rate effect on the fracture pattern on the a-Si, a-Si thin film anode was further cycled with respect to the Li metal in a half cell configuration at different C rates in GenF baseline and LiFSI-3DME-3TTE. FIGS. 7-8 show the discharge capacity and Coulombic efficiency as a function of cycle number.

The overall charge/discharge cycling profiles are shown in FIG. 7, with the cycling performance summarized in FIG. 8. It is manifest that at 2C-rate, LiFSI-3DME-3TTE performs better with the specific capacity estimated 1.6-fold higher than the GenF benchmark. However, at C/3, a-Si anodes cycled in two electrolytes shows very similar capacity values. It is noteworthy that at 2C rate, the a-Si anode cycled in LiFSI-3DME-3TTE exhibits cracks pattern, compared to the “crack-free” pattern observed for a-Si cycled at 1C with the same electrolyte.

When compared to the a-Si cycled with GenF, the total number of cracks per unit area is noticeably smaller (i.e. larger polygonal “islands”). Regardless, it is seen that when cycling with a high current value, LiFSI-3DME-3TTE electrolyte is no longer functional to keep the a-Si “crack-free”. This issue may be ascribed to the uneven current distribution and the consequent heterogeneous Li⁺ ion insertion to the a-Si anode, which is known to cause the uneven stress distribution in Si upon lithiation.

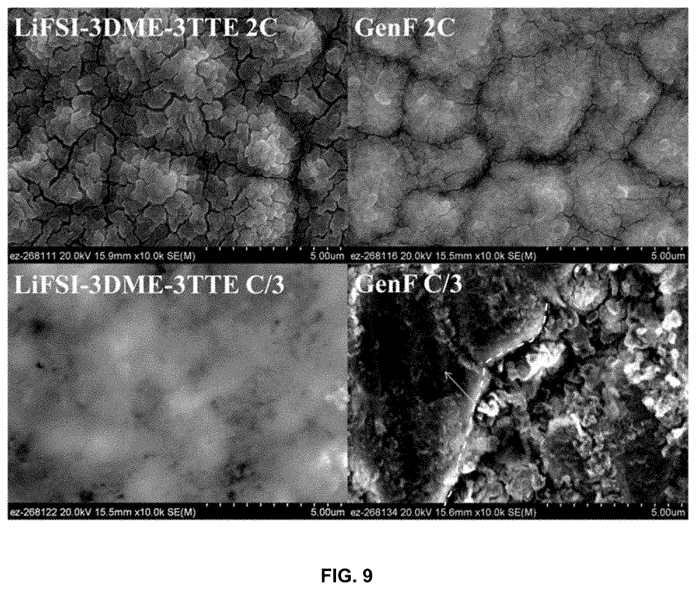

In contrast, at a smaller C rate (C/3), the cracks are mitigated on a-Si cycled in LiFSI-3DME-3TTE, similar to what was observed for a-Si cycled at 1C rate shown in FIG. 9. FIG. 9 shows SEM micrographs of a-Si anodes after 110 cycles in GenF baseline and LiFSI-3DME-3TTE at different C rates (2C and C/3). The arrow points to the under-developed outer SEI layer. The a-Si cycled in GenF baseline, however, still exhibits cracks pattern. The morphological difference between a-Si cycled in GenF at C/3 and 1C is that part of the a-Si is covered with “island” like SEI structure, as shown in FIG. 9. Likely, the “island” like structure is ascribed to the underdeveloped outer SEI layer. Further characterizations on the surface chemistry of the a-Si anodes cycled in different C-rates are necessary for better illustrating the C rate effects on SEI formation and the Si fracture.

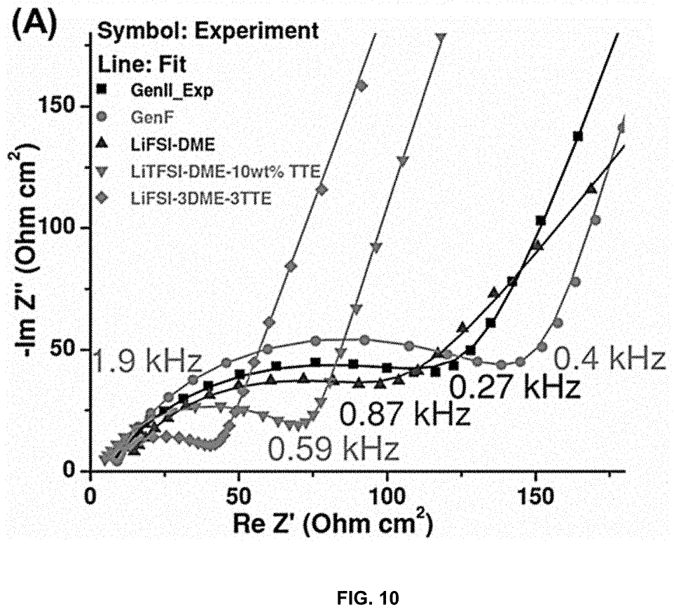

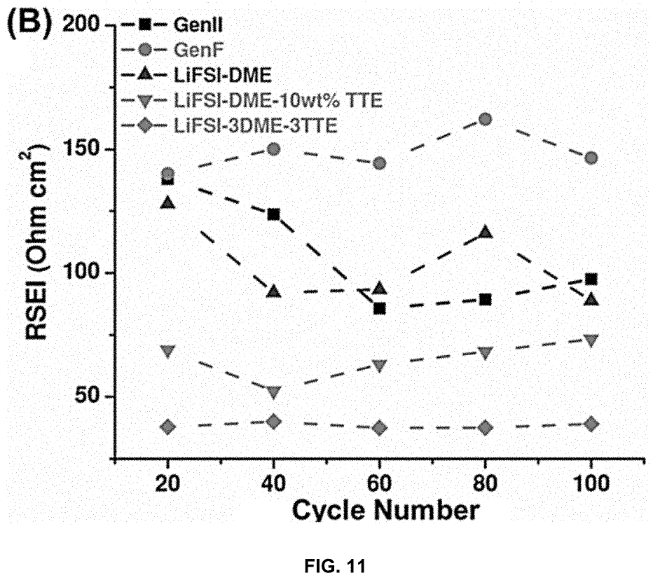

FIG. 10 shows the electrochemical impedance spectroscopy (EIS) plots for various electrolytes at the 100th cycle. The frequency value was taken from the semi-circle top for each sample. FIG. 11 shows values of SEI resistance, RSEI, for various electrolytes at different cycling stages.

EIS plots also reveal that a-Si has the lowest interfacial resistance at prolonged cycles in LiFSI-3DME-3TTE (FIG. 10). Atypical EIS curve is composed of a semicircle at medium to high frequency (1 MHz-50 Hz) and a low frequency (<50 Hz) diffusion tail, as shown in FIG. 10. This type of EIS is best described by an equivalent circuit of 6 elements: R_{electrolyte}+[Q_{SEI}//R_{SEI}]+[Q_{SE}//(R_{SE}+W_{d})], where the high frequency intercept on the real impedance axis, R_{electrolyte} represents the electrolyte Ohmic loss; the parallel RC circuit, Q_{SEI}//R_{SEI}, represents the resistance from the charge transport across the SEI on a-Si, resistance from charge transport in the SEI, and an additional RC circuit indicates the surface electron transfer process (QSE and RSE). The Warburg circuit element, Wd models the lithium diffusion resistance in bulk a-Si anode and Q is the constant phase element, representative of nearly capacitive impedance components in the circuit. The experimental and fitted EIS spectra are in good agreement with the suggested equivalent circuit, averaging less than 1.5% deviation as calculated by weighted sum of squares (FIG. 10). A plot of the R_{SEI} vs. cycle number is shown in FIG. 11. While the value of R_{SEI} for LiFSI-3DME-3TTE stabilizes at 38.3±0.9 Ω/cm² after the 20th cycle, R_{SEI} of other electrolytes fluctuates as cycling proceeds, suggesting a lack of passivation layer on a-Si. Notably, the overall interfacial resistance of LiFSI-3DME-3TTE electrolyte is one quarter that of its GenF counterpart. These results indicate prospective benefits for improved rate performance for Si anodes with glyme electrolytes due to the reduced internal resistance.

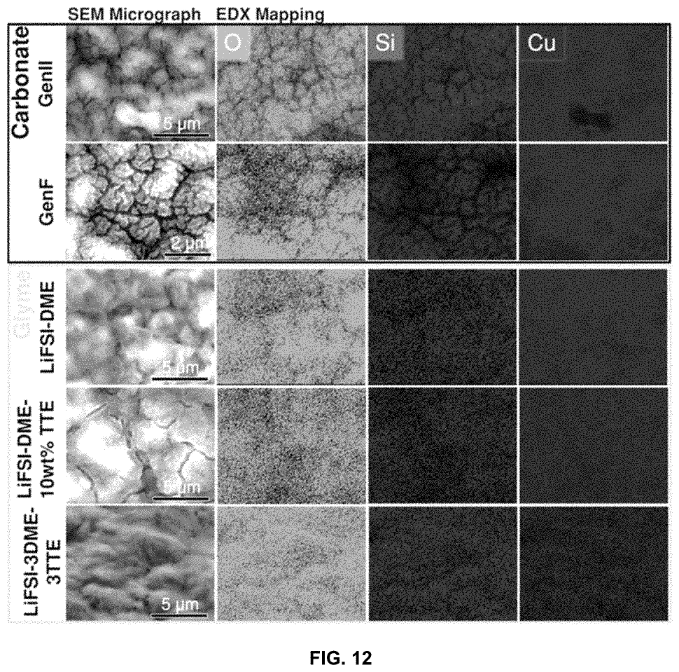

FIG. 12 shows SEM micrographs and corresponding EDX maps of a-Si anodes after 110 cycles in various electrolytes. The oxygen and silicon mappings represent the SEI and Si distribution on Cu foil, respectively. Cu maps are complementary to Si maps, where underlying Cu is exposed in fractured regions of the Si.

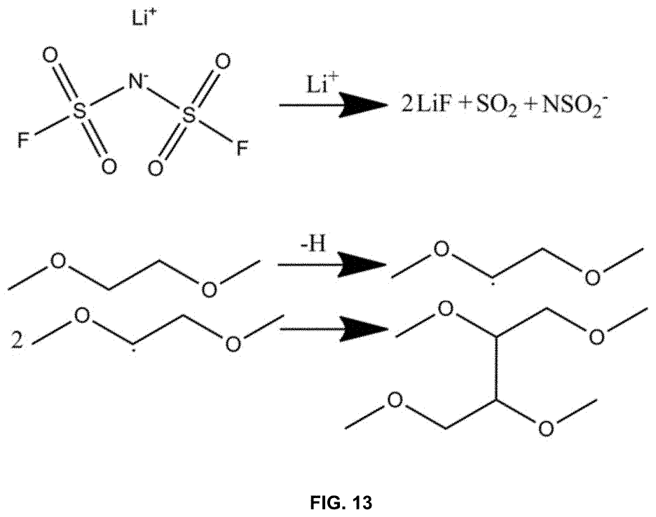

FIG. 13 shows a possible reaction scheme of generation of a more protective SEI layer from glyme electrolyte. A possible cross-linking decomposition mechanism of glyme solvent is illustrated. An ethane group in the middle may lose hydrogen to form a DME. radical. Crosslinking reactions could then occur among the glyme. radicals to form a polyether network and benefit a more elastic SEI.

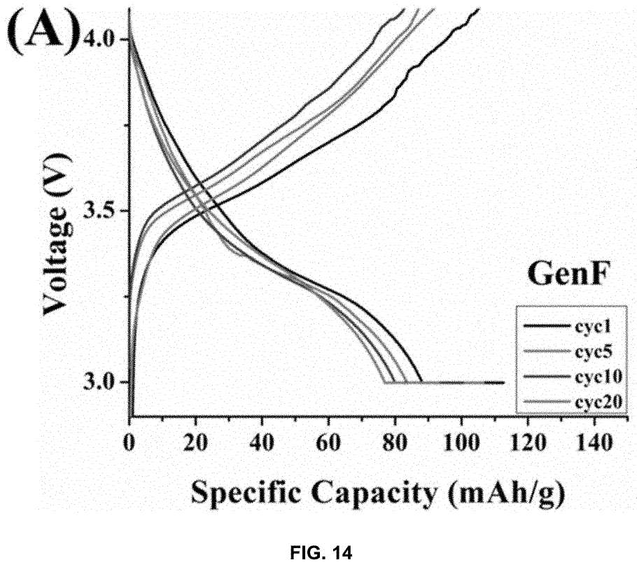

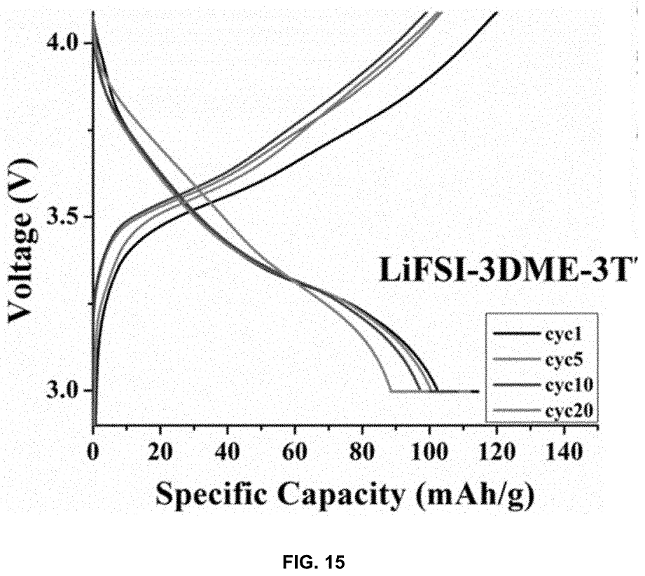

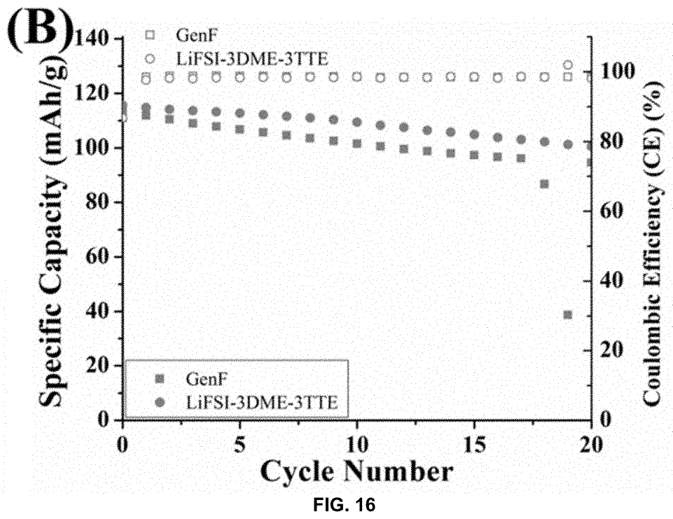

To evaluate the performance of the glyme electrolyte with more practical electrodes, a proof-of-concept full cell test using the particle-based composite Si anode and a high voltage LiNi_{0.5}Mn_{0.3}Co_{0.2}O₂(NMC532) cathode was performed. FIGS. 14, 15, and 16 show the galvanostatic cycling performance of the Si composite electrode/NMC532 full cells using different electrolytes. FIG. 14 shows charge-discharge curves for Si composite electrode/NMC532 full cells cycled using GenF and FIG. 15 shows charge-discharge curves for Si composite electrode/NMC532 full cells cycled using LiFSI-3DME-3TTE electrolyte. FIG. 16 shows the cycling performance of the Si composite electrode/NMC532 full cells evaluated based on the discharge capacity as a function of the cycle number. The hollow symbols indicate Coulombic efficiency. As shown in FIGS. 14-16, the charge/discharge galvanostatic cycling curve looks similar for LiFSI-3DME-3TTE benchmarked to GenF. Overall, cycled with LiFSI-3DME-3TTE electrolyte, the Si-NMC(532) full cell shows marginally higher discharge capacity in 20 cycles. It indicates that the glyme electrolytes are potentially compatible with high voltage cathodes.

The particle-based silicon was used as the model anode (150 nm Si particle, 60 wt %, Timcal super C45, 20 wt % and lithium polyacrylate binder 20 wt %). The active material loading is 0.7 mg/cm². The LiNi_{0.5}Mn_{0.3}Co_{0.2}O₂ (NMC532) was used as the cathode, with the active material loading of 10.11 mg/cm². Each Si-NMC532 full cell was cycled between 3 and 4.1 V vs. Li/Li⁺. Three formation cycles at C/10 (0.165 mA/cm²) were performed for each cell, followed by galvanostatic cycling at C/3. A voltage hold step at 3V was implemented at the end of each discharge cycle until the discharge current dropped down to C/100.

Benchmarked to the GenF baseline, the LiFSI-3DME-3TTE electrolyte shows marginally higher discharge capacity. For example, for baseline GenF, the lithiation capacity is 113.8 mAh/g, compared to the Si-NMC532 full cell cycled with LiFSI-3DME-3TTE at 115.7 mAh/g. The Si-NMC532 full cell cycled with LiFSI-3DME-3TTE has a discharge capacity of 100.5 mAh/g at the 20th cycle, 5.5 mAh/g higher than the GenF benchmark.

This proof-of-concept experiment demonstrates that glyme electrolytes can potentially work with a practical particle-based Si anode paired with a high voltage cathode in a full cell format. The high voltage stability agrees with a similar study where Glyme electrolytes were used with high voltage nickel rich cathodes in a lithium metal battery. Further developments in optimized glyme electrolyte constituents (salt, solvent and additive) and compatible binders for particle-based Si anode will improve the Si-NMC full cell performance.

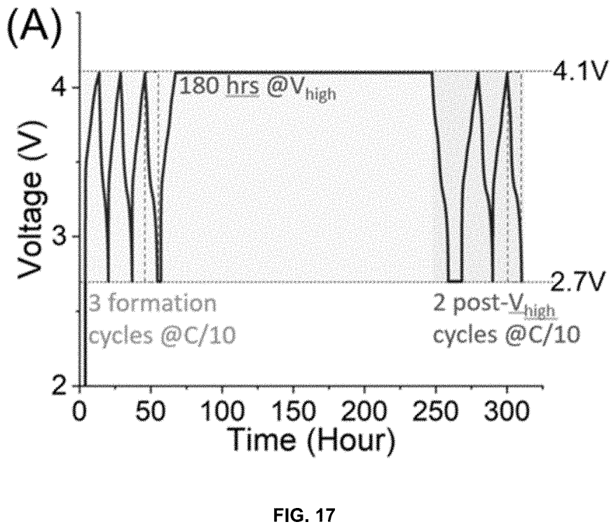

The calendar life test is used to predict the long-term stability of the Si anode using a high-voltage hold strategy. During the voltage hold stage, the electrolyte tends to react with the cathode, leading to undesired capacity loss. The higher the current of the side reaction is, the quicker the capacity fade is for a Si-NMC full cell. The calendar life test protocol is illustrated in FIG. 17. The Si/NMC622 full cell is cycled at C/10 equivalent rate for three cycles. The cell is charged to a high SOC (i.e. 4.1 V vs. Si) followed by a 180-hour high voltage holding, or calendar aging period to evaluate the parasitic reactions in the Si/NMC622 full cell. Two diagnostic galvanostatic cycles is performed at C/10 rate. Holding the cell at a high SOC would yield continuous side reactions between the electrolytes and the two electrodes, if any, thereby potentially accelerating cell failure resulted from the inadequate electrode passivation. Two types of electrolytes were used in the current study. The best performing carbonate electrolyte, GenF was used as the baseline electrolyte. The dual salt and dual salt with a phosphate additive, N2FC were explored as non-carbonate counterparts against GenF.

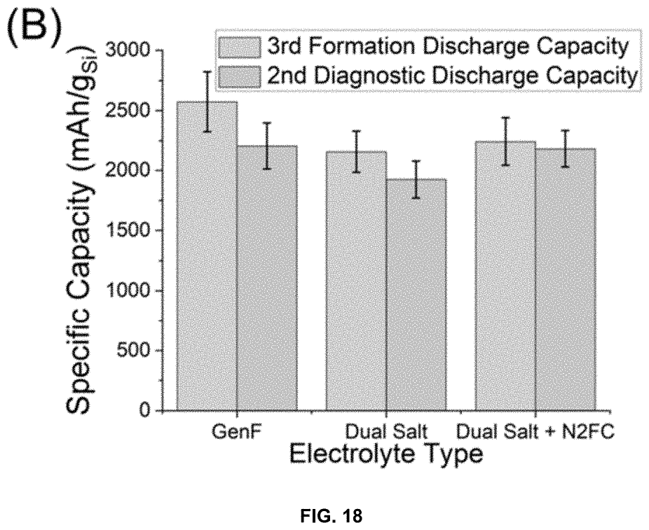

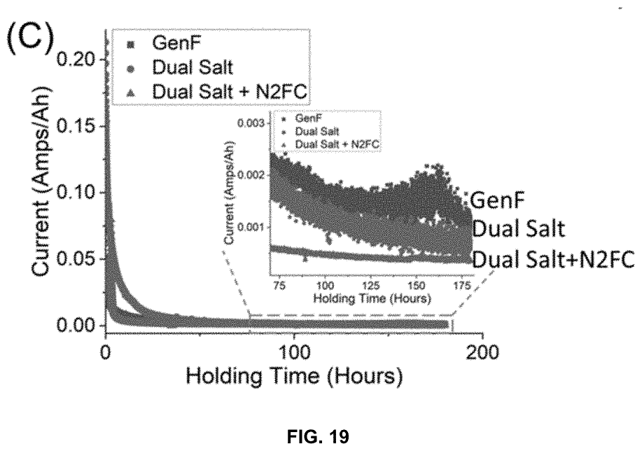

FIGS. 17, 18, and 19 show the calendar life test protocol and outcomes of Si/NMC full cells with different electrolytes. FIG. 17 is the calendar life evaluation protocol launched by the U.S. Department of Energy Silicon Consortium Project. FIG. 18 is a comparison of the discharge capacity of the third formation cycle and the second diagnostic cycle for different electrolytes. Comparison of the irreversible capacity resulted from the parasitic current during the high SOC hold among all electrolytes can be explored through two means. The first method is to compare the discharge capacity difference between the last formation cycle and the second diagnostic cycle, as shown in FIG. 18. Despite of its highest formation capacity for GenF, its average capacity loss highest among the three electrolytes. The use of dual salt electrolyte has reduced the capacity loss. Addition of a phosphate N2FC additive further reduced the capacity loss to <5%. The second method is to compare the leakage current at the end of the high SOC holding period. It is assumed that all redox reactions contributing to the reversible capacity have been accomplished in the beginning of the high voltage holding period. Any finite current at the end of the high-voltage holding stage results from the side reactions between the electrolyte and the Si and NMC622 electrodes. FIG. 19 shows the parasitic current of GenF, Dual Salt and Dual Salt+N2FC additive during the 180-hour holding period at 4.1V (Inset: magnified view of the parasitic current after 74 hours 4.1V-holding). As shown in FIG. 19, the current (normalized to the discharge capacity of the 3^{rd} formation cycle) of the dual salt+N2FC was lower and more convergent at the end of the high voltage holding period than GenF and dual salt electrolytes, indicative of its fewer parasitic reactions and possibly better electrode passivation in the Si/NMC full cell.

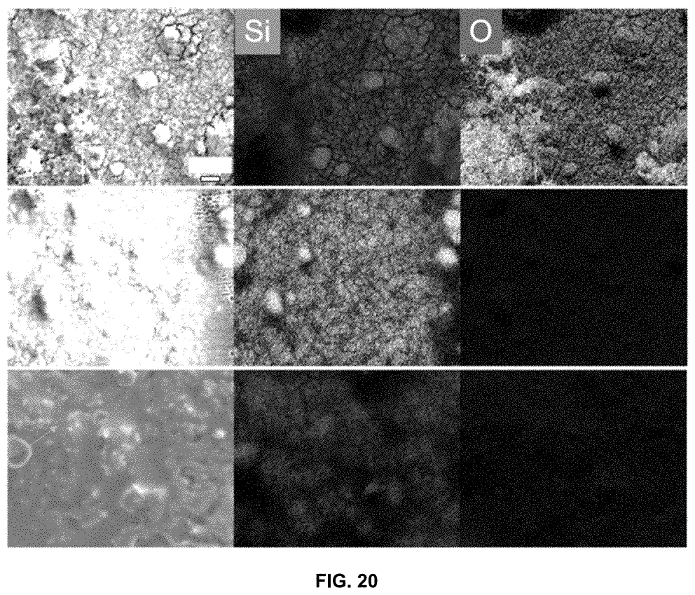

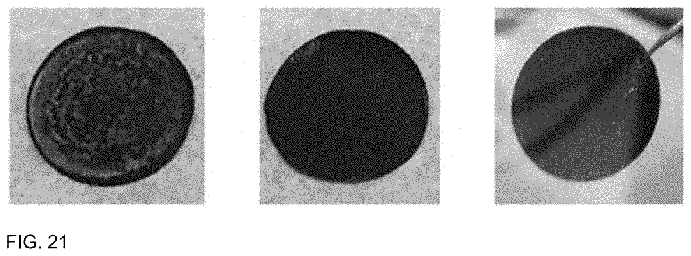

To explore the mechanisms of how dual salt electrolytes facilitate improvement of the calendar life in the Si/NMC full cell, a series of post-cycling morphological and chemical characterizations were implemented on Si and NMC electrodes. The integrity of the electrodes after calendar life aging was first evaluated by optical images. The immediate observation was that the anodic materials chipped and partially detached from the copper current collector after calendar aging in GenF (FIG. 21). FIG. 21 is a photograph which shows that the Si flakes from the current collector after calendar life with GenF carbonate electrolytes. The Si anode integrity was retained for glyme electrolytes. In contrast, the anode integrity was preserved in both dual salt and duals salt+N2FC electrolytes. The SEM micrograph and corresponding EDX element maps were further used to study the local morphological and chemical changes of the Si and NMC electrodes. The Si anode calendar aged in GenF is featured in the crack pattern shown in the SEM image in FIG. 2. The crack pattern becomes less sever for Si cycled in the dual salt electrolyte. With N2FC additive, no crack pattern is distinguishable (FIG. 20). FIG. 20 (Left-most column) is a SEM micrograph of the Si anode after the calendar life test in different electrolytes and (right columns) the corresponding EDX mapping of the same scanned area for each sample. There is no phosphorus species in the dual salt electrolyte. Therefore, its phosphorus EDS mapping vanishes. This observation is further supported by the Si EDX map (FIG. 20). The SEI layer in GenF was heterogeneous, manifested by the oxygen, fluorine, and phosphorus EDX maps. The oxygen component results from the electrolyte solvent decomposition, whereas the fluorine and phosphorus compounds stem from the salt decomposition on Si. The SEI is fractured for GenF, likely resulted from the cracked Si anode. In contrast, the SEI layers after calendar aging in dual salt and dual salt+N2FC electrolytes is more homogeneously distributed on Si surface and crack-free. It clearly indicates that when tested in the Si/NMC622 full cell, the dual salt electrolyte system is capable of retaining the integrity of the Si anode, as well as generating a more robust and protective SEI layer on the Si surface. For all three electrolytes, no crack patterns were observed on the NMC622 cathode after calendar aging. It indicates that the morphological degradation on the anode side for GenF contributes to its larger capacity loss during calendar aging, but cathode morphological evolution should not be as significant in affecting the Si/NMC622 calendar life.

The invention as shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed in accordance with the spirit of the invention, and such changes, alternations and modifications as would occur to those skilled in the art are considered to be within the scope of this invention as broadly defined in the appended claims. In addition, it is to be understood that the phraseology and terminology employed herein are for the purpose of description and should not be regarded as limiting.

We claim:

1. A battery, comprising:
a cathode;
an anode comprising Si;
an electrolyte comprising glyme, and a lithium salt comprising at least one fluorine or boron atom in the anion.

2. The battery of claim 1, wherein the glyme has the formula CH₃(OCH₂CH₂)ₙOCH₃, where 1≤n≤4.

3. The battery of claim 2, wherein the glyme is at least one selected from the group consisting of Dimethoxyethane (glyme), Bis(2-methoxyethyl) ether (diglyme), Triethylene glycol dimethyl ether (triglyme), and Tetraethylene glycol dimethyl ether (tetraglyme).

4. The battery of claim 1, wherein the glyme has the formula CₙH₂ₙOₘ, where 8≥n≥4 and 4≥m≥1.

5. The battery of claim 4, wherein the glyme comprises at least one selected from the group consisting of Tetrahydrofuran, Tetrahydropyran, and 1,4-Dioxane.

6. The battery of claim 1, wherein the electrolyte dynamic viscosity is <5 mm²/s.

7. The battery of claim 1, wherein the mS/cm room temperature ionic conductivity is greater than 1 mS/cm and less than 100 mS/cm.

8. The battery of claim 1, wherein the lithium salt a lithium imide salt.

9. The battery of claim 8, wherein the lithium imide salt is at least one selected from the group consisting of lithium triflouromethanesulfonate (LiOTF), lithium bis(fluorosulfonyl)imide (LiFSI), lithium bis(trifluoromethanesulfonyl)imide (LiTFSI), lithium triflorite (LiTf), lithium bis(pentafluoroethanesulfonyl)imide (LiBETI).

10. The battery of claim 1, wherein the lithium salt is a lithium borate salt.

11. The battery of claim 9, wherein the lithium borate salt is at least one selected from the group consisting of lithium bis(oxalato)borate (LiBOB), lithium tetrafluoroborate (LiBF₄), and lithium difluoro(oxalato)borate (LiODFB).

12. The battery of claim 1, wherein the glyme comprises ether oxygen, and the molar ratio of lithium salt to ether oxygen is less than 5:1.

13. The battery of claim 1, comprising a mixture of at least one lithium imide salt and at least one lithium borate salt.

14. The battery of claim 13, wherein the molar ratio of lithium imide salt to lithium borate salt is ≥1:1.

15. The battery of claim 1, wherein the electrolyte further comprises an additive, wherein the additive has low solubility for the lithium salts such that the additive does not change the coordination of the ions in the glyme, has a viscosity<1 cP at 25° C., and is miscible with the glyme.

16. The battery of claim 15, wherein the molar ratio of glyme to additive is ≥1:1.

17. The battery of claim 15, wherein the additive has an electrochemical stability window>4.2V.

18. The battery of claim 15, wherein the additive comprises at least one selected from the group consisting of fluoroethers and fluoroesters.

19. The battery of claim 18, wherein the additive is a fluoroether comprising at least one selected from the group consisting of 2,2,3,3-tetrafluoropropyl ether (TTE), bis(2,2,2-trifluoroethyl) ether (BTFE), and 1,1,2,2-tetrafluoroethyl-2,2,3,3-tetrafluoropropyl ether.

20. The battery of claim 18, wherein the additive is a fluoroester.

21. The battery of claim 20, wherein the flouroester is fluoroethylene carbonate.

22. The battery of claim 1, wherein the anode further comprises at least one selected from the group consisting of Ge, Sb and Sn.

23. The battery of claim 1, wherein the cathode is at least one selected from the group consisting of lithium iron phosphate battery low voltage cathodes up to 3.8 V vs. Li, and nickel manganese cobalt (NMC) high voltage cathodes up to 4.2 V vs. Li.

24. The battery of claim 1, wherein the anode further comprises carbon black.

25. An electrolyte for a battery with an anode comprising at least one selected from the group consisting of Si, Ge, Sb and Sn, the electrolyte comprising glyme and a lithium salt having at least one fluorine or boron atom in the anion, the glyme having a formula comprising at least one selected from the group consisting of CH₃(OCH₂CH₂)ₙOCH₃, where 1≤n≤4, and CₙH₂ₙOₘ, where 8≥n≥4 and 4≥m≥1.

26. The electrolyte of claim 25, further comprising an additive, wherein the additive has low solubility for the lithium salts such that the additive does not change the coordination of the ions in the glyme, has a viscosity<1 cP at 25° C., and is miscible with the glyme.

27. A method of making a battery, comprising the steps of:
providing a cathode,
providing an anode comprising at least one selected from the group consisting of Si, Sb, Sn and Ge:
positioning between the anode and the cathode an electrolyte comprising glyme, and a lithium salt comprising at least one fluorine or boron atom in the anion.

28. The method of claim 27, wherein the glyme comprises at least one selected from the group consisting of CH₃(OCH₂CH₂)ₙOCH₃, where 1≤n≤4, and CₙH₂ₙOₘ, where 8≥n≥4 and 4≥m≥1.

29. The method of claim 28, wherein the electrolyte further comprises an additive, wherein the additive has low solubility for the lithium salts such that the additive does not change the coordination of the ions in the glyme, has a viscosity<1 cP at 25° C., and is miscible with the glyme.
